(19) United States
(12) Patent Application Publication
(10) Pub. No.: US 2009/0314375 A1
(43) Pub. Date: Dec. 24, 2009

(54) POLYAMIDE-BASED ANTISTATIC MULTILAYER TUBE FOR TRANSFERRING FLUIDS

(76) Inventors: Jean-Jacques Flat, Goupillieres (FR); Gaelle Bellet, Evreux (FR); Nicolas Amouroux, Kyoto (JP); Benoit Brule, Beaumont Le Roger (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/090,756

(22) PCT Filed: Oct. 17, 2006
(86) PCT No.: PCT/FR06/51041

§ 371 Date: Sep. 26, 2008

Related U.S. Application Data
(60) Provisional application No. 60/758,517, filed on Jan. 12, 2006.

(30) Foreign Application Priority Data
Oct. 18, 2005 (FR) 0510582

(51) Int. Cl. F16L 11/127

(52) U.S. Cl. 138/137

(57) ABSTRACT

The present invention relates to a multilayer tube comprising, in succession in its radial direction from the outside inwards:
a nylon-11 or nylon-12 polyamide outer layer (1);
a tie layer (2);
an optional EVOH layer (3);
an optional layer (4) made of PA-6 or a PA-6/polyolefin blend having a PA-6 matrix and polyolefin dispersed phase;
an inner layer (5) based on PA-6 in contact with the transported fluid, comprising by weight, the total being 100%:
   40 to 65% (advantageously 45 to 60%) of PA-6,
   1 to 20% (advantageously 5 to 15%) of HDPE,
   10 to 30% (advantageously 15 to 25%) of at least one polymer P1 chosen from impact modifiers and polyethylenes, either or both of the HDPE and the P1 being completely or partly functionalized and
   5 to 30% (advantageously 15 to 30% and preferably 17 to 24%) of an electrically conductive material.

The tube of the present invention has a very low permeability to petrol, particularly to hydrocarbons and to their additives, in particular alcohols such as methanol and ethanol or else ethers such as MTBE or ETBE. These tubes also have a very good resistance to fuels and lubricating oils for engines.

This tube has very good mechanical properties at low temperature or at high temperature. The invention also relates to the use of these tubes for transporting petrol.

### FIELD OF THE INVENTION

The present invention relates to polyamide-based antistatic multilayer tubes for transferring fluids.

As examples of tubes for transferring fluids, mention may be made of tubes for transferring petrol, in particular for bringing petrol from the tank to the engine of motor vehicles. In other examples of fluid transfer, mention may be made of the fluids used in fuel cells, in CO₂ systems for cooling and air conditioning, hydraulic systems, cooling circuits, air conditioning and medium-pressure power transfer. The flow of these fluids may generate electrostatic charges, the accumulation of which may result in an electrical discharge. This is important in the case of fluids which can easily catch fire, such as petrol.

For safety and environmental protection reasons, motor vehicle manufacturers require these tubes to have both good mechanical properties, such as strength and flexibility with good cold (−40° C.) impact strength and good high-temperature (125° C.) strength, and very low permeability to hydrocarbons and to their additives, particularly alcohols such as methanol and ethanol. These tubes must also have good resistance to the fuels and lubrication oils of the engine. In motor vehicles, owing to the effect of the injection pump, petrol flows at high speed in the pipes connecting the engine to the tank. In certain cases, friction between the petrol and the internal wall of the tube can generate electrostatic charges, the build-up of which may result in an electrical discharge (or spark) capable of igniting the petrol with catastrophic consequences (an explosion). It is therefore necessary to make the inner surface of the tube in contact with the petrol conducting.

These tubes are manufactured by coextruding the various layers using the standard techniques for thermoplastics.

The present invention relates more particularly to polyamide-based conducting tubes for transporting petrol and in particular for bringing petrol from the tank of a motor vehicle to the engine.

### PRIOR ART AND THE TECHNICAL PROBLEM

Among the characteristics of the specification of the tubes used for petrol, five are particularly difficult to obtain together in a simple manner:
cold (−40° C.) impact strength—the tube must not break;
fuel resistance;
high-temperature (125° C.) strength;
very low permeability to petrol; and
good dimensional stability of the tube when used with petrol.

In multilayer tubes of various structures, the cold impact strength remains unpredictable before standardized tests of cold impact strength have been carried out.

It is known to lower the surface resistivity of polymeric materials or resins by incorporating into them conductive and/or semiconducting materials, such as carbon black, steel fibres, carbon fibres and particles (fibres, flakes, spheres) plated with gold, silver or nickel. Among these materials, carbon black is more particularly employed, for economic and processability reasons. Beside its particular electrically conducting properties, carbon black behaves as a filler, such as for example talc, chalk or kaolin, thereby increasing the flexural modulus of the polymer into which the carbon black has been added. Thus, incorporation of carbon black into a polyamide may embrittle it and the tube comprising this layer may no longer be impact-resistant.

Patent application EP 1036967 discloses a polyamide-based multilayer tube, characterized in that it comprises, in its radial direction, from the inside to the outside:
an inner layer formed from a polyamide or from a polyamide/polyolefin blend having a polyamide matrix, this layer containing a dispersed filler of electrically conductive carbon black, producing a surface resistivity of less than 10⁶Ω;
an intermediate layer formed from a polyamide or from a polyamide/polyolefin blend having a polyamide matrix, this layer not containing electrically conductive carbon black or an electrically significant amount of this carbon black;
a tie layer; and
a polyamide outer layer,
   the above layers adhering to each other in their respective contact region.

In one particular embodiment, the conducting inner layer contains 60 to 70 parts of polyamide, 5 to 15 parts of a compatibilizer and the balance to 100 of HDPE (high-density polyethylene), and also carbon black, that is to say the inner layer is formed from 100 parts of polymer and also carbon black in order to obtain the required resistivity.

Patent application EP 1036968 discloses a polyamide-based multilayer tube, characterized in that it comprises, in its radial direction from the inside to the outside:
a first layer (1) formed from a polyamide P1/polyolefin PO₁ blend having a polyamide P₁ matrix, or else a first layer (1) formed from a polyamide P₁;
a layer (2a) formed from EVOH;
a layer (2) formed from a copolyamide; and
a layer (3) formed from a polyamide P₃,
   in which P₁ and P₃ may be identical or different and the layers (1), (2a), (2) and (3) being successive and adhering to each other in their respective contact region.

In one particular embodiment, the conducting inner layer contains 60 to 70 parts of polyamide, 5 to 15 parts of a compatibilizer and the balance to 100 of HDPE (high-density polyethylene) and also carbon black, that is to say the inner layer is formed from 100 parts of polymer and in addition carbon black in order to obtain the required resistivity.

Patent application US 2002 0142118 discloses a petrol tube comprising, coming from the outside to the inside:
a PA-6,12 outer layer, a polyamidepolyamine-based tie layer, an EVOH layer and a PA-6 inner layer in contact with the petrol. The PA-6 layer may be conducting, but no details are given about its composition.

It has now been found that in the above tubes comprising, starting from the outside, a polyamide layer, a tie layer, optionally an EVOH layer, a conducting inner layer in contact with the transported fluid and optionally one or more other layers subjected to impacts or to other equivalent mechanical stresses, cracks may appear and propagate into the entire structure. It has been discovered that the inner layer in contact with the transported fluid has to be formulated in such a way that it cannot initiate the cracking of the tube.

It has also been discovered that the inner layer in contact with the petrol must necessarily contain HDPE in order to improve the petrol barrier.

### BRIEF DESCRIPTION OF THE INVENTION

The present invention relates to a multilayer tube comprising, in succession in its radial direction from the outside inwards:
a nylon-11 or nylon-12 polyamide outer layer (1);
a tie layer (2);
an optional EVOH layer (3);
an optional layer (4) made of PA-6 or a PA-6/polyolefin blend having a PA-6 matrix and polyolefin dispersed phase; and
an inner layer (5) based on PA-6 in contact with the transported fluid, comprising by weight, the total being 100%:
   40 to 65% (advantageously 45 to 60%) of PA-6,
   1 to 20% (advantageously 5 to 15%) of HDPE,
   10 to 30% (advantageously 15 to 25%) of at least one polymer P1 chosen from impact modifiers and polyethylenes, either or both of the HDPE and the P1 being completely or partly functionalized and
   5 to 30% (advantageously 15 to 30% and preferably 17 to 24%) of an electrically conductive material.

In one particular embodiment, the inner layer (5) based on PA-6 in contact with the transported fluid comprises by weight, the total being 100%:
45 to 49% of PA-6;
8 to 12% of HDPE;
18 to 22% of at least one polymer P1 chosen from impact modifiers and polyethylenes, either or both of the HDPE and the P1 being completely or partly functionalized; and
20 to 24% of an electrically conductive material.

The proportion of electrically conductive material is chosen so as to obtain a surface resistivity of preferably less than 10⁶Ω. The surface resistivity may also be expressed in ohms, this unit having the dimension of ohms.

These tubes may also have an outside diameter of 6 to 110 mm and a thickness of around 0.5 to 5 mm.

Advantageously, the petrol tube according to the invention has an outside diameter ranging from 6 to 12 mm and a total thickness of 0.8 mm to 2.5 mm. The thickness of the outer layer (1) represents between 25 and 60% of the thickness of the tube. The thickness of the combination of layers (4) and (5) represents 30 to 50% of the thickness of the tube. If the layer (4) is present, the thickness of the layer (5) advantageously represents 5 to 20% of the thickness of the combination of layers (4) and (5).

The tube of the present invention has a very low permeability to petrol, particularly to hydrocarbons and to their additives, in particular alcohols such as methanol and ethanol, or else ethers such as MTBE or ETBE. These tubes also exhibit good resistance to fuels and lubricating oils for engines.

This tube has very good mechanical properties at low or high temperature. The invention also relates to the use of these tubes for transporting petrol.

### DETAILED DESCRIPTION OF THE INVENTION

With regard to the polyamide of the outer layer (1), its inherent viscosity may be between 1 and 2 and advantageously between 1.2 and 1.8. The inherent viscosity is measured at 20° C. for a 0.5% concentration in meta-cresol. The polyamide of the outer layer (1) may contain from 0 to 30% by weight of at least one product chosen from plasticizers and impact modifiers per 100 to 70% polyamide respectively. This polyamide may contain the usual additives: UV stabilizers, thermal stabilizers, antioxidants, fire retardants, etc.

The polyamide of the outer layer (1) may contain at least one product chosen from plasticizers, impact modifiers and catalyzed or uncatalyzed polyamides.

With regard to plasticizers, these are chosen from benzenesulphonamide derivatives, such as N-butylbenzenesulphonamide (BBSA), ethyltoluene-sulphonamide or N-cyclohexyltoluenesulphonamide; esters of hydroxybenzoic acids, such as 2-ethylhexyl para-hydroxybenzoate and 2-decylhexyl para-hydroxybenzoate; esters or ethers of tetrahydrofurfuryl alcohol, like oligoethyleneoxytetrahydrofurfuryl alcohol, and esters of citric acid or hydroxymalonic acid, such as oligoethyleneoxy malonate. Mention may also be made of decylhexylpara-hydroxybenzoate and ethylhexylparahydroxybenzoate. A particularly preferred plasticizer is N-butylbenzenesulphonamide (BBSA).

With regard to impact modifiers, mention may for example be made of polyolefins, crosslinked polyolefins, elastomers EPR, EPDM, SBS and SEBS, these elastomers possibly being grafted in order to make it easier to compatibilize them with the polyamide, copolymers having polyamide blocks and polyether blocks. These copolymers having polyamide blocks and polyether blocks are known per se and are also denoted by the name PEBA (polyether block-amide) and sold by the Applicant under the name PEBAX®. Mention may also be made of acrylic elastomers, for example those of the NBR, HNBR and X-NBR type. The polyolefins useful as impact modifiers are for example ethylene/alkyl (meth)acrylate/maleic anhydride (or glycidyl methacrylate) copolymers. They are sold by the Applicant under the name LOTADER®.

With regard to catalyzed polyamides, these are polyamides containing a polycondensation catalyst such as a mineral or organic acid, for example phosphoric acid. The catalyst may be added to the polyamide after it has been prepared by any process or, quite simply, and this is preferred, it may be the residue of the catalyst used for preparing the polyamide. Polymerization and/or depolymerisation reactions may have taken place to a very substantial extent during the blending of this catalyzed polyamide with the polyamide of the outer layer. The amount of catalyst may be between 5 ppm and 15000 ppm of phosphoric acid relative to the catalyzed polyamide. The amount of catalyst may be up to 3000 ppm and advantageously between 50 and 1000 ppm. For other catalysts, for example boric acid, the contents will be different and may be chosen appropriately according to the usual techniques for polycondensation of polyamides.

The proportion by weight of plasticizer may be between 0 and 15% (advantageously between 4 and 8%), the impact modifier between 0 and 20% (advantageously between 5 and 15%) the catalyzed polyamide between 0 and 20%, advantageously between 10 and 20% (preferably between 12 and 17%) and the balance up to 100% made of polyamide of the outer layer.

Advantageously, the polyamide of the outer layer is PA-12. If catalyzed polyamide is added to this polyamide, then this catalyzed polyamide is advantageously PA-11

With regard to the preparation of the compositions of the outer layer, these may be prepared by melt-blending the constituents using the standard techniques for thermoplastics. The outer layer may also include standard additives for polyamides, such as UV stabilizers, antioxidants, pigments, fire retardants.

With regard to the tie layer (2), this thus denotes any product permitting adhesion between the layers. For example, copolyamides and grafted polyolefins may be mentioned. The 6/12 copolyamide may also be mentioned, this being a copolyamide of caprolactam and lauryllactam. The proportions of caprolactam and lauryllactam may vary from 20 to 80% caprolactam per 80 to 20% lauryllactam respectively. Advantageously, this is a blend of a 6-rich 6/12 copolyamide and of a 12/rich 6/12 copolyamide. With regard to the blend of 6/12 copolyamides, one comprising by weight more 6 than 12 and the other more 12 than 6, the 6/12 copolyamide results from the condensation of caprolactam with lauryllactam. It is clear that “6” denotes caprolactam-derived units and “12” denotes lauryllactam-derived units. It would not be outside the scope of the invention if caprolactam were completely or partly replaced with aminocaproic acid, and likewise lauryllactam may be replaced with aminododecanoic acid. These copolyamides may include other units, provided that the ratio of the proportions of 6 to 12 are respected.

Advantageously, the 6-rich copolyamide comprises 50 to 90% by weight of 6 per 50 to 10% of 12, respectively.

Advantageously, the 12-rich copolyamide comprises 50 to 90% by weight of 12 per 50 to 10% of 6, respectively.

As regards the proportions of the 6-rich copolyamide and of the 12-rich copolyamide, these may be from 30/70 to 70/30 and preferably from 40/60 to 60/40 by weight.

These copolyamide blends may also comprise up to 30 parts by weight of other grafted polyolefins or (co)polyamides by 100 parts of 6-rich and 12-rich copolyamides.

These copolyamides of a melting point (DIN standard 53736B) of between 60 and 200° C. and their relative solution viscosity may be between 1.3 and 2.2 (DIN standard 53727: solvent: m-cresol; concentration: 0.5 g/100 ml; temperature: 25° C.; Ubbelohde viscometer). Their melt rheology is preferably close to that of the materials of the adjacent layers. These products are manufactured by standard techniques for polyamides. Processes are described in the U.S. Pat. No. 4,424,864, U.S. Pat. No. 4,483,975, U.S. Pat. No. 4,774,139, U.S. Pat. No. 5,459,230, U.S. Pat. No. 5,489,667, U.S. Pat. No. 5,750,232 and U.S. Pat. No. 5,254,641.

Mention may also be made of the ties described in patent application US 2002 0142118, the content of which is incorporated in the present application. These are polyamidepolyamines prepared from polyamines having at least 4 nitrogen atoms and either lactams or a blend of diamines and diacids. These polyamidepolyamines may be made as a blend with polyamides, such as PA-12 and PA-6,12, and optionally impact modifiers such as EPR and grafted EPR.

This tie layer may contain stabilizers. According to one embodiment of the invention, this tie layer may contain at least one impact modifier. This impact modifier may be chosen from the impact modifiers described above in the case of the outer layer (1).

With regard to the layer (3), the EVOH copolymer is also called a saponified ethylene/vinyl acetate copolymer. The saponified ethylene/vinyl acetate copolymer to be employed according to the present invention is a copolymer having an ethylene content of 20 to 70 mol %, preferably 25 to 45 mol %, the degree of saponification of its vinyl acetate component being not less than 95 mol %. Among these saponified copolymers, those that have a melt flow index (MFI) within the range from 0.5 to 100 g/10 minutes are particularly useful. Advantageously, the MFI is chosen between 5 and 30 (g/10 min at 230° C. under 2.16 kg).

It should be understood that this saponified copolymer may contain small proportions of other comonomer ingredients, including α-olefins, such as propylene, isobutene, α-octene, α-dodecene, α-octadecene, etc., unsaturated carboxylic acids or their salts, partial alkyl esters, complete alkyl esters, nitriles, amides and anhydrides of the said acids, and unsaturated sulphonic acids or their salts.

The EVOH layer may consist of blends based on EVOH. As regards EVOH-based blends, these are such that the EVOH forms the matrix, that is to say it represents at least 40% and preferably at least 50% by weight of the blend. The other constituents of the blend are chosen from optionally functionalized polyolefins, polyamides and impact modifiers. The impact modifier may be chosen from elastomers, copolymers of ethylene with an olefin from 4 to 10 carbon atoms (for example ethylene/octane copolymers), and very low-density polyethylenes. Examples of elastomers that may be mentioned include EPR and EPDM. EPR (abbreviation for ethylene propylene rubber) denotes ethylene-propylene elastomers and EPDM denotes ethylene-propylene-diene monomer elastomers. As examples, mention may be made of blends comprising, by weight, 50 to 95% EVOH per 50 to 5% grafted EPR respectively, advantageously 60 to 95% EVOH per 40 to 5% grafted EPR respectively and preferably 75 to 95% EVOH per 25 to 5% grafted EPR respectively.

As examples of EVOH-based blends, mention may also be made of compositions comprising:
50 to 95% by weight of an EVOH copolymer; and
5 to 50% by weight of an optionally completely or partly functionalized elastomer or of a blend of a functionalized elastomer and of another elastomer that is not functionalized.

With regard to the layer (4), and to the PA-6 and PA-6/polyolefin blends having a PA-6 matrix and a polyolefin dispersed phase. In PA-6/polyolefin blends having a PA-6 matrix and a polyolefin dispersed phase, the term “polyolefin” denotes both homopolymers and copolymers and denotes thermoplastics or elastomers. For example, these are ethylene/α-olefin copolymers. These polyolefins may be PEs, EPRs or EPDMs. They may be completely or partly functionalized. The dispersed phase may be a blend of one or more unfunctionlized polyolefins with one or more functionalized polyolefins. Advantageously, the PA-6 matrix represents 50 to 85% by weight per 50 to 15% of dispersed phase respectively. Preferably, the PA-6 matrix represents 55 to 80% by weight per 45 to 20% of dispersed phase respectively.

According to a preferred embodiment, the PA-6/polyolefin blends having a PA-6 matrix comprise by weight, the total being 100%:
50 to 90% (advantageously 60 to 80%) of PA-6;
1 to 35% (advantageously 10 to 30%) of HDPE; and
1 to 30% (advantageously 5 to 25%) of at least one polymer P1 chosen from impact modifiers and polyethylenes,
   either or both of the HDPE and the P1 being completely or partly functionalized.

Advantageously, the impact modifier is chosen from elastomers and very low-density polyethylenes.

With regard to the impact modifier and firstly to the elastomers, mention may be made of SBS, SIS and SEBS block copolymers and ethylene-propylene (EPR) or ethylene-propylene-diene monomer (EPDM) elastomers. As regards very low-density polyethylenes, these are for example metallocenes with a density for example between 0.860 and 0.900.

Advantageously, an ethylene-propylene (EPR) or ethylene-propylene-diene monomer (EPDM) elastomer is used. The functionalization may be provided by grafting or by copolymerization with an unsaturated carboxylic acid. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkaline metal salts) of unsaturated carboxylic acids.

Unsaturated dicarboxylic acids having 4 to 10 carbon atoms and their functional derivatives, particular their anhydrides, are particularly preferred grafting monomers. Advantageously, maleic anhydride is used.

The proportion of the combination of functionalized HDPE and functionalized P1 relative to the combination of functionalized and unfunctionalized HDPE and functionalized and unfunctionalized P1 may be between 1 and 80%, advantageously between 5 and 70% and preferably between 20 and 70% by weight. Expressed otherwise, the proportion of HDPE and P1 that are functionalized relative to the total amount of HDPE and P1 may be between 1 and 80%, advantageously between 5 and 70% and preferably between 20 and 70% by weight.

The PA-6/polyolefin blends having a PA-6 matrix may be prepared by melt-blending the various constituents in standard equipment used in the thermoplastic polymer industry.

In a first embodiment of these PA-6/polyolefin blends having a PA-6 matrix, the HDPE is not grafted and P1 is a grafted elastomer/ungrafted elastomer blend.

In another embodiment of these PA-6/polyolefin blends having a PA-6 matrix, the HDPE is not grafted and P1 is a grafted polyethylene optionally blended with an elastomer.

As examples of P1, mention may also be made of a blend (A) of at least one high-density polyethylene (A1) with at least one ethylene copolymer (A2), the (A1)/(A2) blend being cografted with a monomer such as an unsaturated acid or carboxylic acid an hydride or derivatives thereof and the said cografted blend (A) having an MI₁₀/MI₂ ratio of greater than 18.5, MI₁₀ denoting the melt index at 190° C. under a load of 10 kg and MI₂ denoting the index under a load of 2.16 kg.

(A2) may be chosen from EPR, VLDPE, ethylene/alkyl(meth)acrylate copolymers and ethylene/alkyl(meth)acrylate/maleic anhydride copolymers.

Advantageously, the MI₁₀/MI₂ ratio is less than 35 and preferably between 22 and 33.

Advantageously, the MI₂₀ of the blend (A) of cografted polymers (A1) and (A2) is less than 24, MI₂₀ denoting the melt index at 190° C. under a load of 21.6 kg.

The layer (4) may contain stabilizers and one or more plasticizers.

With regard to the inner layer (5), the polymer P1 has already been described above in the case of the layer (4). The polymer P1 of the layer (5) and that of the layer (4) may be identical or different. The proportions of functionalized HDPE and P1 relative to the total amount of HDPE and P1 may be chosen within the ranges of values mentioned above in the case of the layer (4). As examples of electrically conductive materials, mention may be made of carbon black, carbon fibres and carbon nanotubes. It is advantageous to use a carbon black chosen from those having a BET specific surface area, measured according to the ASTM D3037-89 standard, of 5 to 200 m²/g and a DBP absorption, measured according to the ASTM D2414-90 standard, of 50 to 300 ml/100 g. These carbon blacks are described in the patent application WO 99/33908, the content of which is incorporated into the present application.

The layer (5) may contain stabilizers and one or more plasticizers.

### EXAMPLES

| | Layer (5) in % by weight |
|---|---|
| Ultramid ®B3 PA-6 from BASF | 47.3 |
| 2003 SN 53 HDPE from Arkema | 10 |
| Ensaco ® 250 carbon black from Timcal | 22 |
| g-EPR (Exxelor VA 1803) impact modifier | 20 |
| Stabilizer (Irganox 1098 + Irgafos 168) | 0.7 |

The carbon black was provided by Timcal under the name “Ensaco 250 Granular”, the DBP absorption being 190 ml/g and the BET specific surface area being about 65 m²/g.

A tube with an outside diameter of 8 mm and a thickness of 1 mm was extruded at 20 m/min using a multilayer McNeil® extruder, the tube having the following structure:

PA-12 (outer)/tie/EVOH/layer(4)/layer(5) and the layer thicknesses (in μm) were 400(outside layer)/50/100/400/50.

The tie was a blend of (i) 40% by weight of 6/12 copolyamide containing 40% of 6 units and (ii) 60% of 6/12 copolyamide containing 70% of 6 units.

EVOH denotes an EVOH copolymer containing 32 mol % of ethylene sold under the name Soarnol® DC3203F by Nippon Goshei.

The layer (4) consisted of a blend comprising 65% PA-6, 15% HDPE and 20% grafted EPR, and also containing antioxidants.

All these structures were extruded at 20 m/min using a multilayer McNeil® extruder. Unless otherwise indicated, the percentages are by weight.

The surface resistivity of the layer (5) was measured, this being much less than 10⁶ ohms. The tube passed the −40° C. impact test of the GM (General Motors) standard and the VW (Volkswagen) standard.

1. A multilayer tube comprising, in succession in its radial direction from the outside to the inside:
a polyamide outer layer (1);
a tie layer (2);
an optional EVOH layer (3);
an optional layer (4) comprising PA-6 or a PA-6/polyolefin blend having a PA-6 matrix and polyolefin dispersed phase; and
an inner layer (5) comprising PA-6 in contact with the transported fluid, wherein said inner layer (5) comprises by weight, the total being 100%:
40 to 65% of PA-6,
0 to 20% of HDPE,
10 to 30% of at least one polymer P1 chosen from impact modifiers and polyethylenes, either or both of the HDPE and the P1 being completely or partly functionalized and
5 to 30% of an electrically conductive material.

2. The multilayer tube according to claim 1, wherein the proportions of the layer (5) are, the total being 100%:
45 to 60% of PA-6;
5 to 15% of HDPE;
15 to 25% of at least one polymer P1 chosen from impact modifiers and polyethylenes, either or both of the HDPE and the P1 being completely or partly functionalized; and
5 to 30% of an electrically conductive material.

3. The multilayer tube according to claim 1, in which the proportion of electrically conductive material of the layer (5) is between 15 and 30%.

4. The multilayer tube according to claim 3, in which the proportion of electrically conductive material of the layer (5) is between 17 and 24%.

5. The multilayer tube according to claim 1, in which, in the layer (4), the PA-6/polyolefin blends having a PA-6 matrix comprise by weight, the total being 100%:
50 to 90% of PA-6;
1 to 35% of HDPE; and
1 to 30% of at least one polymer P1 chosen from impact modifiers and polyethylenes,
either or both of the HDPE and the P1 being completely or partly functionalized.

6. The multilayer tube according to claim 5, in which the proportions of the layer (4) are, the total being 100%:
60 to 80% of PA-6;
10 to 30% of HDPE; and
5 to 25% of at least one polymer P1 chosen from impact modifiers and polyethylenes,
either or both of the HDPE and the P1 being completely or partly functionalized.

7. A multiplayer tube according to claim 1, used for transporting petrol.

8. The multilayer tube according to claim 1, wherein the composition of the inner layer (5) further comprises at least one additive chosen from plasticizers and stabilizers.

9. The multilayer tube of claim 1, wherein said outer polyamide layer comprises nylon-11 or nylon-12.

10. The multilayer tube of claim 1, wherein said inner tube (5) comprises 1 to 20% of HDPE.
